(19) United States
(12) Patent Application Publication
(10) Pub. No.: US 2020/0134426 A1
(43) Pub. Date: Apr. 30, 2020

(54) AUTONOMOUS SYSTEM INCLUDING A CONTINUALLY LEARNING WORLD MODEL AND RELATED METHODS

(71) Applicant: HRL LABORATORIES, LLC, Malibu, CA (US)

(72) Inventors: Nicholas A. Ketz, Madison, WI (US); Praveen K. Pilly, West Hills, CA (US); Soheil Kolouri, Agoura Hills, CA (US); Charles E. Martin, Thousand Oaks, CA (US); Michael D. Howard, Westlake Village, CA (US)

(21) Appl. No.: 16/548,560

(22) Filed: Aug. 22, 2019

Related U.S. Application Data
(60) Provisional application No. 62/749,819, filed on Oct. 24, 2018.

(51) Int. Cl. G06N 3/04; G06F 17/15

(52) U.S. Cl. CPC G06N 3/0454; G06F 17/15; G06N 3/0472

(57) ABSTRACT

An autonomous or semi-autonomous system includes a temporal prediction network configured to process a first set of samples from an environment of the system during performance of a first task, a controller configured to process the first set of samples from the environment and a hidden state output by the temporal prediction network, a preserved copy of the temporal prediction network, and a preserved copy of the controller. The preserved copy of the temporal prediction network and the preserved copy of the controller are configured to generate simulated rollouts, and the system is configured to interleave the simulated rollouts with a second set of samples from the environment during performance of a second task to preserve knowledge of the temporal prediction network for performing the first task.

### CROSS-REFERENCE TO RELATED APPLICATION(S)

This application claims priority to and the benefit of U.S. Provisional Application No. 62/749,819, filed Oct. 24, 2018, the entire contents of which are incorporated herein by reference.

### STATEMENT REGARDING FEDERALLY SPONSORED RESEARCH OR DEVELOPMENT

This invention was made with U.S. Government support under Government Contract No. FA8750-18-C-0103 awarded by AFRL/DARPA. The U.S. Government has certain rights to this invention.

### BACKGROUND

### 1. Field

The present disclosure relates generally to artificial neural networks for autonomous or semi-autonomous systems, and methods of training these artificial neural networks.

### 2. Description of the Related Art

Complex tasks, such as image recognition, computer vision, speech recognition, and medical diagnoses, are increasingly being performed by artificial neural networks. Artificial neural networks are commonly trained by being presented with a set of examples that have been manually identified as either a positive training example (e.g., an example of the type of image or sound the artificial neural network is intended to recognize or identify) or a negative training example (e.g., an example of the type of image or sound the artificial neural network is intended not to recognize or identify).

Artificial neural networks include a collection of nodes, referred to as artificial neurons, connected to each other via synapses. The connections between the neurons have weights that are adjusted as the artificial neural network learns, which increase or decrease the strength of the signal at the connection depending on whether the connection between those neurons produced a desired behavior of the network (e.g., the correct classification of an image or a sound). Additionally, the artificial neurons are typically aggregated into layers, such as an input layer, an output layer, and one or more hidden layers between the input and output layers, that may perform different kinds of transformations on their inputs.

However, many artificial neural networks are susceptible to a phenomenon known as catastrophic forgetting in which the artificial neural network rapidly forgets previously learned tasks when presented with new training data.

### SUMMARY

The present disclosure is directed to various embodiments of an autonomous or semi-autonomous system. In one embodiment, the system includes a temporal prediction network configured to process a first set of samples from an environment of the system during performance of a first task, a controller configured to process the first set of samples from the environment and a hidden state output by the temporal prediction network, a preserved copy of the temporal prediction network, and a preserved copy of the controller. The preserved copy of the temporal prediction network and the preserved copy of the controller are configured to generate simulated rollouts, and the system is configured to interleave the simulated rollouts with a second set of samples from the environment during performance of a second task to preserve knowledge of the temporal prediction network for performing the first task.

The system may include an auto-encoder configured to embed the first set of samples from the environment of the system into a latent space.

The auto-encoder may be a convolutional variational auto-encoder.

The controller may be a stochastic gradient-descent based reinforcement learning controller.

The controller may include an A2C algorithm.

The temporal prediction network may include a Long Short-Term Memory (LSTM) layer and a Mixture Density Network.

The controller may be configured to output an action distribution, and sampled actions from the action distribution may maximize an expected reward on the first task.

The present disclosure is also directed to various embodiments of a non-transitory computer-readable storage medium having software instructions stored therein, which, when executed by a processor, cause the processor to train a temporal prediction network on a first set of samples from an environment of an autonomous or semi-autonomous system during performance of a first task, train a controller on the first set of samples from the environment and a hidden state output by the temporal prediction network, store a preserved copy of the temporal prediction network, store a preserved copy of the controller, generate simulated rollouts from the preserved copy of the temporal prediction network and the preserved copy of the controller, and interleave the simulated rollouts with a second set of samples from the environment during performance of a second task to preserve knowledge of the temporal prediction network for performing the first task.

The software instructions, when executed by the processor, may further cause the processor to embed, with an auto-encoder, the first set of samples into a latent space.

The auto-encoder may be a convolutional variational auto-encoder.

Training the controller may utilize policy distillation including a cross-entropy loss function with a specific temperature.

The specific temperature may be 0.01.

The controller may be a stochastic gradient-descent based reinforcement learning controller.

The controller may include an A2C algorithm.

The temporal prediction network may include a Long Short-Term Memory (LSTM) layer and a Mixture Density Network.

The software instructions, when executed by the processor, may further cause the processor to output an action distribution from the controller, and sampled actions from the action distribution may maximize an expected reward on the first task.

The present disclosure is also directed to various embodiments of a method of training an autonomous or semi-autonomous system. In one embodiment, the method includes training a temporal prediction network to perform a 1-time-step prediction on a first set of samples from an environment of the system during performance of a first task, training a controller to generate an action distribution based on the first set of samples and a hidden state of the temporal prediction network, wherein sampled actions of the action distribution maximize an expected reward on the first task, preserving the temporal prediction network and the controller as a preserved copy of the temporal prediction network and a preserved copy of the controller, respectively, generating simulated rollouts from the preserved copy of the temporal prediction network and the preserved copy of the controller, and interleaving the simulated rollouts with a second set of samples from the environment during performance of a second task to preserve knowledge of the temporal prediction network for performing the first task.

Training the controller may utilize policy distillation including a cross-entropy loss function with a specific temperature of 0.01.

The method may include embedding, with a convolutional auto-encoder, the first set of samples collected during performance of the first task into a latent space.

The controller may be a stochastic gradient-descent based reinforcement learning controller including an A2C algorithm.

The temporal prediction network may include a Long Short-Term Memory (LSTM) layer and a Mixture Density Network.

This summary is provided to introduce a selection of features and concepts of embodiments of the present disclosure that are further described below in the detailed description. This summary is not intended to identify key or essential features of the claimed subject matter, nor is it intended to be used in limiting the scope of the claimed subject matter. One or more of the described features may be combined with one or more other described features to provide a workable device.

### BRIEF DESCRIPTION OF THE DRAWINGS

The features and advantages of embodiments of the present disclosure will become more apparent by reference to the following detailed description when considered in conjunction with the following drawings. In the drawings, like reference numerals are used throughout the figures to reference like features and components. The figures are not necessarily drawn to scale.

Additionally, the patent or application file contains at least one drawing executed in color. Copies of this patent or patent application publication with color drawing(s) will be provided by the Office upon request and payment of the necessary fee.

FIG. 1 is a schematic layout view of a system according to one embodiment of the present disclosure incorporated into an autonomous or semi-autonomous system;

FIG. 2 is a flowchart illustrating tasks of a method of developing, training, and utilizing the system illustrated in FIG. 1 according to one embodiment of the present disclosure;

FIG. 3A depicts three graphs showing the performance curves for three different tasks and compares the performance for each task when simulated rollouts were interleaved with real experiences during training according to one embodiment of the present disclosure against the performance for each task when no interleaving of simulated rollouts with the real experiences occurred;

FIG. 3B is a graph comparing the percentage of total integrated loss according to one embodiment of the present disclosure with pseudo-rehearsal and a comparative example without pseudo-rehearsal;

FIG. 3C is a graph depicting the pair-wise difference in total loss between the embodiment of the present disclosure with pseudo-rehearsal and the comparative example without pseudo-rehearsal for each of three different tasks; and

FIG. 4A-4C depict the reconstruction of test rollouts from a videogame when no pseudo-rehearsal was utilized in training (i.e., no interleaving of simulated rollouts with the real experiences occurred), the reconstruction of test rollouts from the videogame when pseudo-rehearsal occurred in training (i.e., simulated rollouts were interleaved with the real experiences), and the real rollouts from the environment, respectively.

### DETAILED DESCRIPTION

The present disclosure is directed to various embodiments of artificial neural networks that are part of an autonomous or semi-autonomous system, and various methods of training artificial neural networks that are part of an autonomous or semi-autonomous system. The artificial neural networks of the present disclosure are configured to learn new tasks without forgetting the tasks they have already learned (i.e., learn new tasks without suffering catastrophic forgetting). The artificial neural networks and methods of the present disclosure are configured to learn a model of the environment the autonomous or semi-autonomous system is exposed to, and thereby perform a temporal prediction of the next input to the autonomous or semi-autonomous system conditioned or dependent on the current input to the system and the action(s) chosen by other portions of the system. In one or more embodiments, this temporal prediction is then fed back to the system as an input, which produces a subsequent temporal prediction that itself is fed back as input to the system. In this manner, embodiments of the present disclosure can provide or produce temporally consistent rollouts of simulated experiences, which can then be interleaved with real experiences to preserve the knowledge that already exists within the system. Producing temporally consistent rollouts of simulated experiences allows for the underlying autonomous or semi-autonomous system to have a wider variety of architectures that may require temporally consistent samples as opposed to a random sampling of disjointed experiences (i.e., non-temporally consistent experiences). Additionally, embodiments of the present disclosure are configured to generate these temporally consistent rollouts of simulated experiences based either on a random starting seed or a particular starting seed of interest (e.g., a particular condition or task of interest). In one or more embodiments, the systems and methods of the present disclosure utilize the current input to the autonomous or semi-autonomous system as the seed, which enables performing simulated rollouts of near-term potential scenarios to aid in action selection and/or system evaluation.

In one or more embodiments, the systems and methods of the present disclosure may be embedded or incorporated into an autonomous or semi-autonomous system that needs to continually perform a task or set of tasks within an unbounded environment such that the scope of conditions in which the autonomous or semi-autonomous system is anticipated to perform is at least partially known (i.e., the conditions under which the autonomous or semi-autonomous system will perform is not fully known a priori). For instance, in one or more embodiments, the systems and methods of the present disclosure may be embedded or incorporated into an autonomous or semi-autonomous system that is desired to perform the same task but under varying conditions (e.g., autonomous or semi-autonomous driving in dry weather conditions and snowy conditions) as well as perform different tasks under the same conditions (e.g., navigating a web interface to enable a user to select and book an airplane flight and to select and book a car rental). Accordingly, the embodiments of the present disclosure, which enable continual learning without catastrophic forgetting, enable the deployment of an autonomous or semi-autonomous system in an environment where the global scope of the system is not defined a prior, but rather is defined during deployment (e.g., the systems and methods of the present disclosure may be incorporated into an autonomous or semi-autonomous system operating in an underspecified environment with uncontrolled conditions). For example, the embodiments of the present disclosure may enable an autonomous or semi-autonomous system to learn to navigate in a variety of conditions (e.g., wet, icy, foggy) without the need for specifying what all those conditions would be a priori, or re-experiencing the various conditions it has already learned to perform well in. For instance, the methods of the present disclosure would enable, for example, a self-driving car to learn to recognize tricycles without forgetting how to recognize bicycles, and would enable an unmanned aerial vehicle to learn how to land in a cross wind without forgetting how to take off in the rain. Similarly, an autonomous or semi-autonomous system (e.g., an unsupervised robot) that has already learned to perform a specific task (e.g., loading baggage) can then be trained to perform a new task on demand (e.g., washing windows) while also retaining its ability to perform its original task. The autonomous or semi-autonomous system may be, for example, a self-driving car or an unmanned aerial vehicle.

In one or more embodiments, the systems and methods of the present disclosure are configured to accommodate non-binary input/output structures (e.g., the systems and methods of the present disclosure do not require experiences to be segmented into labeled tasks or conditions). Additionally, in one or more embodiments, the systems and methods of the present disclosure are configured to interpret the output of the system in its original domain for utilization by the autonomous or semi-autonomous system in evaluating potential action selection plans for near-term events (e.g., the systems and methods of the present disclosure integrate all experiences in a unified set of weights, rather than a disjointed set that would limit transfer between tasks/conditions). Furthermore, in one or more embodiments, the systems and methods of the present disclosure are configured to preserve knowledge in sophisticated learning methods, such as policy gradient reinforcement learning agents, due to the sequential nature of the simulated rollouts.

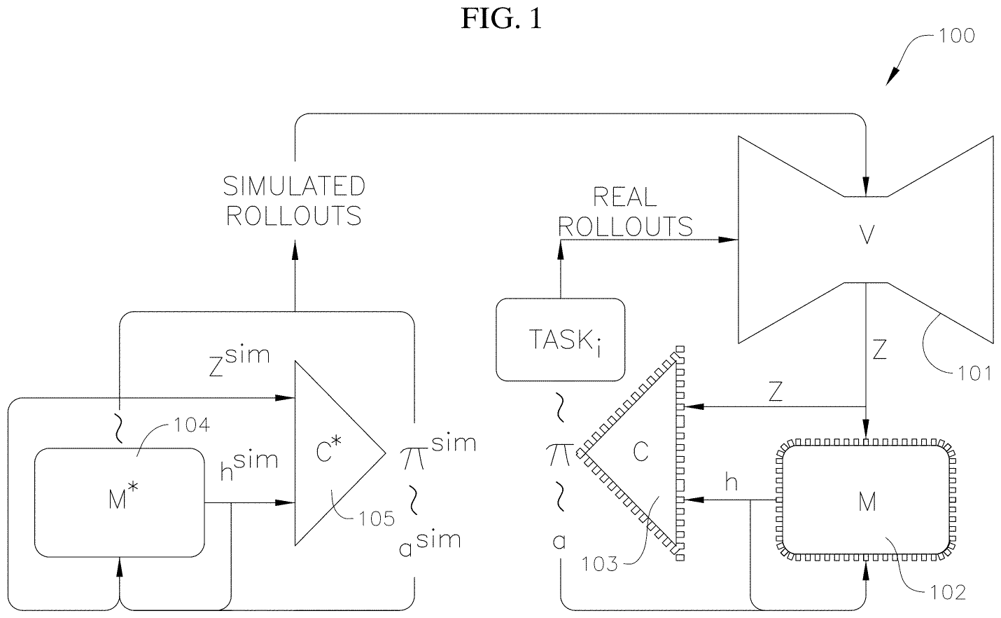

With reference now to FIG. 1, a system 100 according to one embodiment of the present disclosure that is incorporated or integrated into an autonomous or semi-autonomous system includes an auto-encoder 101, a temporal prediction network 102, and an agent or controller 103. The auto-encoder 101 is trained to compress a high dimensional input (e.g., images from a scene, such as video captured by a camera) into a smaller latent space (z) and also allow for a reconstruction of the latent space (z) back into the high dimensional space. In the illustrated embodiment, the latent space representation (z) output by the auto-encoder 101 is input into the temporal prediction network 102. The temporal prediction network 102 is trained to predict one time step into the future and to output a hidden state (h). In one or more embodiments, the system 100 may not include the auto-encoder 101, for example, if the input dimensions of the input are sufficiently small such that embedding is unnecessary. As used herein, the phrases “latent space” and “latent vector” represent an observation.

Auto-encoders are a type of artificial neural network that may be utilized to learn a representation for a data set, such as for dimensionality reduction, in an unsupervised manner. In one or more embodiments, the auto-encoder 101 may be a variational auto-encoder (VAE). In one or more embodiments in which the auto-encoder 101 is a VAE, the auto-encoder 101 is configured to learn to both encode and reconstruct observed samples (e.g., images of the environment in which the autonomous or semi-autonomous system is operating) into a latent embedding by optimizing a combination of reconstruction error of the samples from the embedding back into the original observational space, and the Kullback-Leibler (KL) divergence of the samples from the prior distribution on the latent space (e.g., factored Gaussian with a mean of 0 and a standard deviation of 1) on the embedding space those samples are encoding into. In one or more embodiments, the auto-encoder 101 may be a convolutional VAE. In one or more embodiments, the auto-encoder 101 may be a convolutional VAE with the same architecture as described in David Ha and Jürgen Schmidhuber, “Recurrent world models facilitate policy evolution,” Advances in Neural Information Processing Systems, pages 2455-2467, 2018, the entire contents of which are incorporated herein by reference. In one or more embodiments, the convolutional VAE 101 may be configured to pass the input images through four convolutional layers (32, 64, 128, and 256 filters, respectively) each with a 4×4 weight kernel and a stride of 2. The output of the four convolutional layers is passed through a fully connected linear layer onto a mean and standard deviation value for each of the dimensions of the latent space, which is then utilized by the temporal prediction network 102 and the controller 103 to sample from the latent space, as described in more detail below. For reconstruction of the latent space back into the high dimensional space, the convolutional VAE 101 includes a set of deconvolution layers, mirroring the convolution layers, that are configured to take the latent representation as an input and produce an output in the same dimensions as the original input (e.g., the high dimensional space). In one or more embodiments, all activation functions of the convolutional VAE 101 are rectified linear except the last layer, which utilizes a sigmoid activation function to constrain the activation to a value between 0 and 1.

In the illustrated embodiment, the temporal prediction network 102 is configured to take the latent space (z) and pass it through a Long Short-Term Memory (LSTM) layer. The output from the LSTM layer is then concatenated with the current action taken by the autonomous or semi-autonomous system and input to a Mixture Density Network, which passes the input through a linear layer onto an output representation that is the mean and standard deviation used to determine a specific normal distribution, and a set of mixture parameters used to weight those separate distributions in each of the dimensions of the latent space (z) output from the auto-encoder 101. The output from the temporal prediction network 102 also includes the predicted reward and the predicted episode termination probability.

In the illustrated embodiment, the controller 103 takes as input the hidden state h output from the temporal prediction network 102 concatenated with the current latent vector (z) output by the auto-encoder 101 (i.e., the outputs of the auto-encoder 101 and the temporal prediction network 102 are utilized as a latent state-space for the controller 103). In one or more embodiments, the controller 102 may be a stochastic gradient-descent based reinforcement learning controller. In one or more embodiments, the controller 103 may include an Actor-Critic algorithm, such as, for example, the A2C algorithm, which is the synchronous adaption of the original A3C algorithm described in Volodymyr Mnih, Adria Puigdomenech Badia, Mehdi Mirza, Alex Graves, Timothy Lillicrap, Tim Harley, David Silver, and Koray Kavukcuoglu, “Asynchronous methods for deep reinforcement learning,” International conference on machine learning, pages 1928-1937, 2016, the entire contents of which are incorporated herein by reference.

In the illustrated embodiment, the controller 103 is configured (i.e., trained) to output, based on the hidden state h and the current latent vector z, a distribution of actions π such that sampled actions a from the action distribution π maximize the expected reward on the same task that the temporal prediction network 102 was trained on. The sampled action a from the action distribution π is fed back into the temporal prediction network 102 to generate the real rollouts.

In the illustrated embodiment, the system 100 also includes a preserved copy of the temporal prediction network 104 and a preserved copy of the controller 105 (i.e., the trained temporal prediction network 102 and the trained controller 103 are preserved, such as by storing them in memory). The preserved copy of the temporal prediction network 104 and the preserved copy of the controller 105 are configured to generate samples from simulated past experiences, which may be interleaved with samples from actual experiences during training on subsequent tasks. In the illustrated embodiment, the preserved copy of the temporal prediction network 104 is configured to produce a first simulated observation z^{sim} and a hidden state h^{sim}. The first simulated observation z^{sim} and the hidden state h^{sim} are provided to the preserved copy of the controller 105, which outputs a first distribution of potential actions π^{sim} and a particular action a^{sim} sampled from the first distribution of potential actions π^{sim}. The sampled action a^{sim} from the action distribution π^{sim} is fed back into the preserved copy of the temporal prediction network 104 to generate the simulated rollouts of the pseudo-samples. As described in more detail below, these simulated rollouts are then interleaved with the real rollouts to preserve the knowledge that already exists within the system 100 and thereby prevent or at least mitigate against catastrophic forgetting by the temporal prediction network 102.

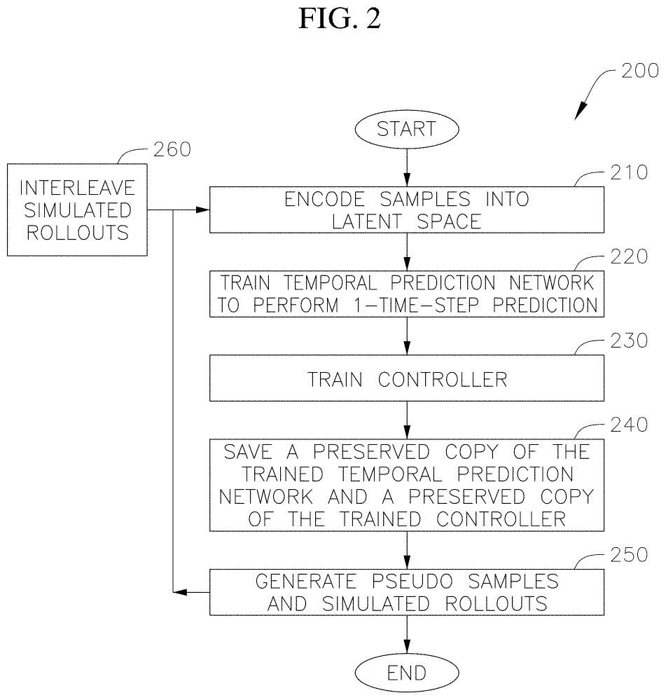

FIG. 2 is a flowchart illustrating tasks of a method 200 of developing, training, and utilizing the system 100 illustrated in FIG. 1. In the illustrated embodiment, the method 200 includes a step (act) 210 of training and/or obtaining the auto-encoder 101, and utilizing the auto-encoder 101 to embed high-dimensional samples from all potential environments into a lower-dimensional space (i.e., a latent space). In one or more embodiments, the method 200 may not include the step 210 of training and/or obtaining the auto-encoder 101, for example, if the input dimensions are sufficiently small.

In the illustrated embodiment, the step 210 of generating the latent space includes first sampling a particular task for a particular duration to train on. In one or more embodiments, the step 210 includes collecting data from the environment utilizing a random action selection policy. During the step 210, the rollouts of [[zₜ, aₜ, rₜ, dₜ]_{{Tmax}}]_{{N}} are saved (e.g., stored in memory), where t is a given time step, zₜ is the latent representation of the current observation produced by the auto-encoder 101, aₜ is the chosen action, rₜ is the observed reward, and dₜ is the binary done state of the episode. For each task exposure, N rollouts are collected, and each rollout is allowed to proceed until the binary done state dₜ is 1 or it reaches the maximum number of recorded time-steps Tmax.

In the illustrated embodiment, the method 200 also includes a step (act) 220 of training the temporal prediction network 102 to perform a 1-time-step prediction of the next input to the autonomous or semi-autonomous system based on the rollouts [[zₜ, aₜ, rₜ, dₜ]_{{Tmax}}]_{{N}} saved in step 210.

In the illustrated embodiment, the method 200 also includes a step (act) 230 of training the controller 103 to produce an action distribution π such that sampled actions a from the action distribution π maximize the expected reward on the same task that the temporal prediction network 102 was trained on in step 220. In one or more embodiments, the network of the controller 102 utilizes as input the latent embedding of the current observation zₜ output by the encoder 101 and the current hidden state hₜ of the trained temporal prediction network 102. During step 230 of the method 200, the network of the controller 103 is trained for n_steps within the current task.

In the illustrated embodiment, following the steps of 220 and 230 of training the temporal prediction network 102 and the controller 103, the method 200 includes a step (act) 240 of saving the trained temporal prediction network 102 and the trained controller 103 as the preserved copy of the temporal prediction network 104 and the preserved copy of the controller 105, respectively.

In the illustrated embodiment, the method 200 includes a step (act) 250 of sampling a new task for a particular duration and generating pseudo-samples (pseudo-rollouts) from the preserved copy of the temporal prediction network 104 and the preserved copy of the controller 105 that were generated in step 240. The pseudo-samples generated from the preserved copy of the temporal prediction network 104 and the preserved copy of the controller 105 are to be interleaved with real samples from new incoming tasks. In one or more embodiments, the step 250 includes processing the current task through the preserved copy of the temporal prediction network 104 and the preserved copy of the controller 105, which generates a new set of real rollouts. In one or more embodiments, the preserved copy of the temporal prediction network 104 and the preserved copy of the controller 105 can generate either real or simulated rollouts (the simulated rollouts require sampling a predicted z, whereas the real rollouts use the true z that is observed). In one or more embodiments, the step 250 includes providing an encoded observation (z) from the current task, which is output by the auto-encoder 101, to the preserved copy of the temporal prediction network 104 and then to the preserved copy of the controller 105, which produces a particular action that yields rollouts in the form [[zₜ, aₜ, rₜ, dₜ]_{{Tmax}}]_{{N}}. In one or more embodiments, the temporal prediction network 102 and the preserved copy of the temporal prediction network 104 each provide a prediction of what the next z will be on the next timestep z_{{t+1}}, and simulated rollouts are created by continually feeding the predicted z back onto the system to get an estimate of subsequent predictions (z_{{t+2}}, z_{{t+3}} . . . z_{{t+n}}) would be. In one or more embodiments, the process of generating the simulated rollouts then starts by picking a random point in the latent space (z) sampled based on the prior of the auto-encoder 101, which may be a diagonal multi-variate Gaussian distribution with a mean of zero and a standard deviation of 1, along with a zeroed-out hidden state and a randomly sampled action. The task 250 also includes inputting the randomly selected point in the latent space (z) to the preserved copy of the temporal prediction network 104, which produces a first simulated observation (z₀^{sim}) and a hidden state (h₀^{sim}). The first simulated observation (z₀^{sim}) and the hidden state (h₀^{sim}) are then provided to the preserved copy of the controller 105, which generates a first distribution of potential actions π₀^{sim} and the particular action a₀^{sim} sampled from that distribution of potential actions π₀^{sim}. This process continues utilizing the last sample a₀^{sim} as the input to the preserved copy of the temporal prediction network 104, and the [zₜ^{sim}, aₜ^{sim}, rₜ^{sim}, dₜ^{sim}, πₜ^{sim}] tuples are stacked in time to produce the simulated rollouts of the pseudo-samples.

These simulated rollouts of the pseudo-samples are simulations of the tasks the network has already been exposed to, and these simulated rollouts can then be interleaved, in step 260, with new experiences (e.g., new samples from the environment that are encoded by the auto-encoder 101) to preserve the performance of the temporal prediction network 102 and the controller 103 with respect to previously learned tasks. The pseudo-rehearsal updates in the temporal prediction network 102 are the same as from real samples, just using the simulated rollouts in place of real rollouts. In one or more embodiments, updates in the controller 103 network are performed utilizing policy distillation with a cross-entropy loss function having a specific temperature, τ, as described in Andrei A Rusu, Sergio Gomez Colmenarejo, Caglar Gulcehre, Guillaume Desjardins, James Kirkpatrick, Razvan Pascanu, Volodymyr Mnih, Koray Kavukcuoglu, and Raia Hadsell, “Policy distillation,” arXiv preprint arXiv:1511.06295, 2015, the entire contents of which are incorporated herein by reference. In one or more embodiments, specific temperature, τ, is set at 0.01. In one or more embodiments, provided a given simulated sample zₜ^{sim} as input, the temperature modulated softmax of the controller's 103 output distribution

$$( softmax ( \frac{{π}_{t}}{τ} ) )$$

is forced to be similar to the temperature modulated softmax of the simulated output distribution

$$( softmax ( \frac{{π}_{t}^{sim}}{τ} ) )$$

from a preserved copy of the controller 105.

Provided below is code, according to one example embodiment of the present disclosure, for performing the tasks 210-260 described above.

T set of potential tasks
initialize V model parameters
while [symbol] _{VAE}(V) is decreasing do
| Dₐₗₗ ← s ~ T(a_{rand})
| V ← ∇ [symbol] _{VAE}(V, Dₐₗₗ)
end
O ← random training order over T
initialize M, C model parameters
for i in O do
| taskᵢ, durationᵢ ← O(i)
| for n_episodes do
| | #collect training data
| | Dᵣₑₐₗ ~ taskᵢ, C
| | if i > 0 then Dₛᵢₘ ~ M*, C*
| end
| for durationᵢ do
| | #Mixture Density Network updates
| | M ← ∇ [symbol] _{MDN}(M, Dᵣₑₐₗ)
| | if i > 0 then M ← ∇ [symbol] _{MDN}(M, Dₛᵢₘ)
| end
| for n_steps do
| | #Reinforcement Learning
| | C ← ∇ [symbol] _{RL}(C, M(Vtaskᵢ)))
| | #Cross-Entropy Distillation
| | if i >0 then C ← ∇ [symbol] _{CE}(C, Dₛᵢₘ).
| end
| M*, C* ← M, C
end

In one or more embodiments of the method 200, the training of the networks is performed sequentially (e.g., the auto-encoder 101 is trained first, then the temporal prediction network 102 is trained, and lastly the controller 103 is trained). Additionally, in one or more embodiments of the method 200, the training of the networks (e.g., the auto-encoder 101, the temporal prediction network 102, and the controller 103) are entirely unsupervised (e.g., no labelled data is required or provided).

The performance of the systems and methods of the present disclosure, compared to related art systems and methods without interleaving pseudo-samples, was tested by generating 1000 rollouts from all potential tasks in a set of 3 Atari games (RiverRaid, Tutankham, and Crazy Climber), which was done as a proxy for instantiating the system in an autonomous robot. However, the systems and methods of the present disclosure are not limited to utilization in an autonomous robot, and instead, these systems and methods can be instantiated in any agent-based system deployed in any number of environments or tasks where the agent provides actions to the environment and the environment provides rewards and observations to the agent in discrete time intervals.

During testing, each random rollout was generated using a series of randomly sampled actions with a probability of 0.5 that the last action will repeat. These rollouts were constrained to have a minimum duration of 100 samples and a maximum duration of 1,000 samples. The first 900 of these rollouts, for each of the 3 Atari games, were used for training data and the last 100 of these rollouts were reserved for testing. All image observations were reduced to 64×64×3 and were rescaled from 0 to 1. Each of the games was limited to a 6 dimensional action space: “NOOP”, “FIRE”, “UP”, “RIGHT”, “LEFT” and “DOWN”. Each game was run through the Arcade Learning Environment (ALE) and interfaced through the OpenAI Gym. All rewards were clipped as either −1, 0, or 1 based on the sign of the reward, the terminal states were labeled in reference to the ALE game-over signal, and a non-stochastic frame-skipping value of 4 was used. The same environment parameters were used through-out the experiment.

All training images were then fully interleaved to train the auto-encoder 101, which was a VAE, that can encode into and decode out of a 32 dimensional latent space. Training was done using a batch size of 32 and was allowed to continue until 300 epochs of 100,000 samples showed no decrease in test loss greater than 10⁻⁴. Using this pre-trained auto-encoder 101 network to encode the original rollouts into the latent space, the temporal prediction network 102 was then trained over a series of randomly determined task exposures. First, a random training order was determined such that all tasks have the same exposure to training, which was a total of 30 epochs per task. This total of 30 epochs was split over the course of 3 randomly determined training intervals where each has a minimum of 3 epochs and a maximum determined by the floor of the ratio of the total epochs left and the number of training exposures left for a given task. The order over task exposures was then randomized with the exception that the first task and training duration (which has no pseudo-rehearsal) was always the same across random replications. Each epoch of training in the temporal prediction network 102 was done using rollouts of length 32 in 100 batches of 16. Once training of the temporal prediction network 102 was finished for a given task exposure, the output of this trained temporal prediction network 102 was then used as input to the controller 103 network for the same task. In contrast to the random training duration of the temporal prediction network 102, training in the controller 103 network was consistently set to 1 million frames per task exposure.

After every task exposure, the temporal prediction network 102 and the controller 103 network were preserved (e.g., saved in memory) as the preserved copy of the temporal prediction network 104 and the preserved copy of the controller 105, respectively, as illustrated in FIG. 1. The preserved copy of the temporal prediction network 104 and the preserved copy of the controller 105 were then used to generate a set of 1,000 simulated rollouts or pseudo-samples. During the experiment, these simulated rollouts were saved into memory (e.g., RAM) at the start of each task exposure. However, in one or more embodiments, these simulated rollouts may be generated on-demand, rather than saved in memory. These generated simulated rollouts were then interleaved with the next task's training set. Additionally, a set of 1000 real rollouts from the next task were generated using the preserved copy of the temporal prediction network 104 and the preserved copy of the controller 105.

Then, on the next task exposure, the temporal prediction network 102 was updated with 1 simulated rollout to 1 real rollout for the duration determined by the current task exposure. After training temporal prediction network 102, the controller 103 network was allowed to explore the current task. However, for every 30,000 frames from the current task, a batch of 30,000 simulated frames was trained using policy distillation. Training of the controller 103 continued in each task exposure until 1e6 frames (referred to as n_steps above) from the real task had been seen.

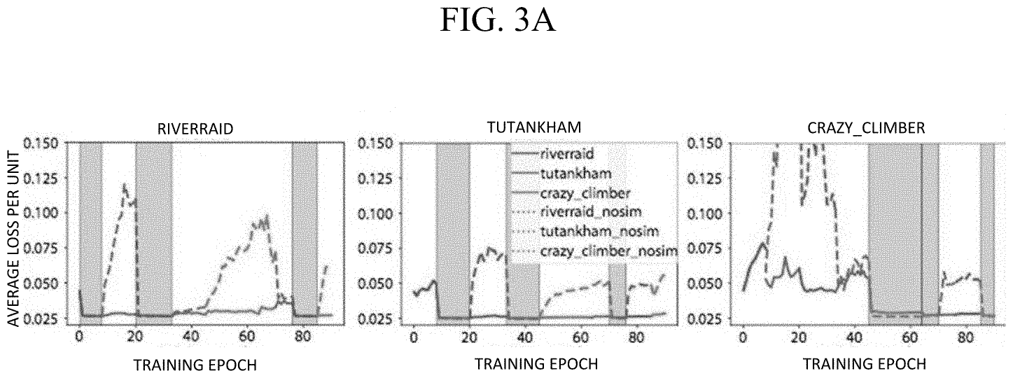

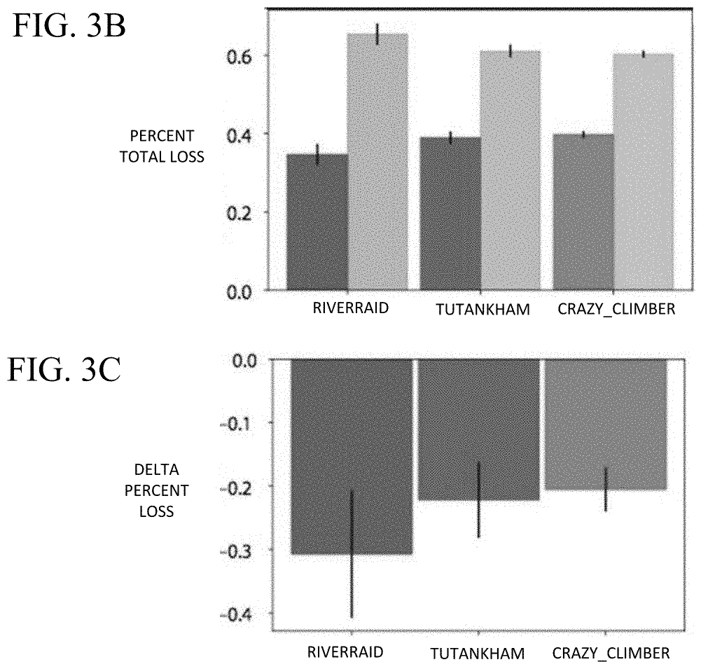

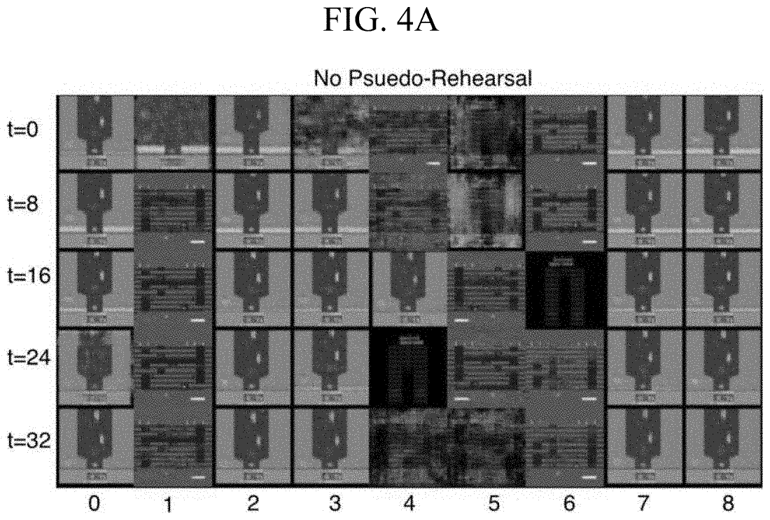

The average loss per output unit in the temporal prediction network 102 was used to assess performance. Performance in the temporal prediction network 102 (i.e., the average loss per output unit) was assessed on the held-out test-set of rollouts for each task and was done on all potential tasks at every epoch of training. A baseline measure of catastrophic forgetting was established by performing the same training as described above with no pseudo-samples interleaved (i.e., not utilizing the preserved copy of the temporal prediction network 104 and the preserved copy of the controller 105 to generate the pseudo-samples). FIG. 3A depicts three graphs showing the performance curves of the temporal prediction network 102 for each of the three different Atari games (RiverRaid, Tutankham, and Crazy Climber) and compares the performance for each task when simulated rollouts were interleaved with real experiences during training according to one embodiment of the present disclosure (e.g., utilizing the preserved copy of the temporal prediction network 104 and the preserved copy of the controller 105 to generate the pseudo-samples, and interleaving these pseudo-samples with real samples from the environment) against the performance for each task when no interleaving of simulated rollouts with the real experiences occurred. In FIG. 3A, the solid lines indicate the performance in the temporal prediction network 102 when simulated rollouts were interleaved during training, and the dashed lines indicate the performance in the temporal prediction network 102 when no interleaving of simulated rollouts occurred (with the label suffix of ‘_nosim’). The different line colors in each curve correspond to when the temporal prediction network 102 was being training on a particular task, as dictated in the legend. The overlaid boxes in FIG. 3A indicate when a given task is engaged in training on its own data. As illustrated in FIG. 3A, clear catastrophic forgetting occurred in the temporal prediction network 102 when no pseudo-samples were interleaved with the real rollouts, whereas relatively little increase in loss in the temporal prediction network 102 occurred when the simulated rollouts were interleaved with the real rollouts according to various embodiments of the present disclosure.

The areas under the performance metric curves in FIG. 3A were integrated over all training epochs and divided by the sum over the two experimental conditions (training with and without pseudo-rehearsal) to achieve a percent performance that sums to one within each task, as shown in FIG. 3B. Performance statistics were calculated over 10 replications where a new random task exposure order was sampled for each replication. in FIG. 3B, the desaturated bars (i.e., the lightly colored bars) show the loss in the temporal prediction network 102 when pseudo-rehearsal was not performed. Additionally, the error bars in FIG. 3B are the standard error of the mean.

FIG. 3C is a graph depicting, for each of the three different Atari games, the pair-wise difference in total loss in the temporal prediction network 102 between when the simulated rollouts were interleaved with real experiences during training according to one embodiment of the present disclosure (e.g., utilizing the preserved copy of the temporal prediction network 104 and the preserved copy of the controller 105 to generate the pseudo-samples, and interleaving these pseudo-samples with real samples from the environment), and when no interleaving of simulated rollouts with the real experiences occurred.

The average percent loss graph shown in FIG. 3B and the pair-wise percent loss difference plot shown in FIG. 3C show that each task was significantly more preserved when using pseudo-rehearsal according to various embodiments of the present disclosure (e.g., utilizing the preserved copy of the temporal prediction network 104 and the preserved copy of the controller 105 to generate the pseudo-samples, and interleaving these pseudo-samples with real samples from the environment).

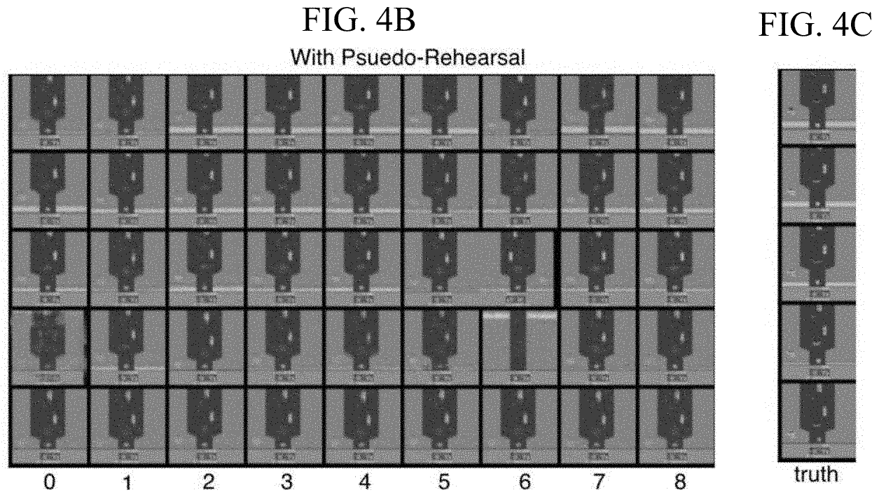

FIGS. 4A-4C depict reconstructions of test rollouts from the Atari videogame RiverRaid across task exposures. FIG. 4A depicts the reconstruction of the test rollouts from the RiverRaid videogame when no pseudo-rehearsal was utilized in training (i.e., no interleaving of simulated rollouts with the real experiences occurred), FIG. 4B depicts the reconstruction of the test rollouts from the RiverRaid videogame when pseudo-rehearsal occurred in training (e.g., utilizing the preserved copy of the temporal prediction network 104 and the preserved copy of the controller 105 to generate the pseudo-samples, and interleaving these pseudo-samples with real samples from the environment), and FIG. 4C depicts the real rollouts from the environment (i.e., the real rollouts from the RiverRaid videogame). In FIGS. 4A-4C, the grid rows correspond to a given rollout's time steps, and the columns are specific rollouts generated after training is complete in each task exposure. FIGS. 4A-4B provide a heuristic for translating the change in loss depicts in FIGS. 3A-3C into appreciable visual samples. FIG. 4A shows clear signs of catastrophic forgetting in the reconstructed samples when pseudo-rollouts (pseudo-samples) were not interleaved with the real rollouts during training of the temporal prediction network 102, whereas FIG. 4B shows a relatively small loss in the reconstructed samples when the pseudo-rollouts were interleaved with the real rollouts during training of the temporal prediction network 102.

The methods, the artificial neural networks (e.g., auto-encoder 101, the temporal prediction network 102, the controller 103, the preserved copy of the temporal prediction network 104, and/or the preserved copy of the controller 105), and/or any other relevant smart devices or components (e.g., smart aircraft or smart vehicle devices or components) according to embodiments of the present invention described herein may be implemented utilizing any suitable smart hardware, firmware (e.g. an application-specific integrated circuit), software, or a combination of software, firmware, and hardware. For example, the various components of the artificial neural network may be formed on one integrated circuit (IC) chip or on separate IC chips. Further, the various components of the artificial neural network may be implemented on a flexible printed circuit film, a tape carrier package (TCP), a printed circuit board (PCB), or formed on one substrate. Further, the various components of the artificial neural network may be a process or thread, running on one or more processors, in one or more computing devices, executing computer program instructions and interacting with other system components for performing the various smart functionalities described herein. The computer program instructions are stored in a memory which may be implemented in a computing device using a standard memory device, such as, for example, a random access memory (RAM). The computer program instructions may also be stored in other non-transitory computer readable media such as, for example, a CD-ROM, flash drive, or the like. Also, a person of skill in the art should recognize that the functionality of various computing devices may be combined or integrated into a single computing device, or the functionality of a particular computing device may be distributed across one or more other computing devices without departing from the scope of the exemplary embodiments of the present invention.

While this invention has been described in detail with particular references to exemplary embodiments thereof, the exemplary embodiments described herein are not intended to be exhaustive or to limit the scope of the invention to the exact forms disclosed. Persons skilled in the art and technology to which this invention pertains will appreciate that alterations and changes in the described structures and methods of assembly and operation can be practiced without meaningfully departing from the principles, spirit, and scope of this invention, as set forth in the following claims, and equivalents thereof.

What is claimed is:

1. An autonomous or semi-autonomous system comprising:
a temporal prediction network configured to process a first set of samples from an environment of the system during performance of a first task;
a controller configured to process the first set of samples from the environment and a hidden state output by the temporal prediction network;
a preserved copy of the temporal prediction network; and
a preserved copy of the controller,
wherein the preserved copy of the temporal prediction network and the preserved copy of the controller are configured to generate simulated rollouts, and
wherein the system is configured to interleave the simulated rollouts with a second set of samples from the environment during performance of a second task to preserve knowledge of the temporal prediction network for performing the first task.

2. The system of claim 1, further comprising an auto-encoder, wherein the auto-encoder is configured to embed the first set of samples from the environment of the system into a latent space.

3. The system of claim 2, wherein the auto-encoder is a convolutional variational auto-encoder.

4. The system of claim 1, wherein the controller is a stochastic gradient-descent based reinforcement learning controller.

5. The system of claim 4, wherein the controller comprises an A2C algorithm.

6. The system of claim 1, wherein the temporal prediction network comprises:
a Long Short-Term Memory (LSTM) layer; and
a Mixture Density Network.

7. The system of claim 1, wherein the controller is configured to output an action distribution, and wherein sampled actions from the action distribution maximize an expected reward on the first task.

8. A non-transitory computer-readable storage medium having software instructions stored therein, which, when executed by a processor, cause the processor to:
train a temporal prediction network on a first set of samples from an environment of an autonomous or semi-autonomous system during performance of a first task;
train a controller on the first set of samples from the environment and a hidden state output by the temporal prediction network;
store a preserved copy of the temporal prediction network;
store a preserved copy of the controller,
generate simulated rollouts from the preserved copy of the temporal prediction network and the preserved copy of the controller; and
interleave the simulated rollouts with a second set of samples from the environment during performance of a second task to preserve knowledge of the temporal prediction network for performing the first task.

9. The non-transitory computer-readable storage medium of claim 8, wherein the software instructions, when executed by the processor, further cause the processor to embed, with an auto-encoder, the first set of samples into a latent space.

10. The non-transitory computer-readable storage medium of claim 9, wherein the auto-encoder is a convolutional variational auto-encoder.

11. The non-transitory computer-readable storage medium of claim 8, wherein training the controller utilizes policy distillation including a cross-entropy loss function with a specific temperature.

12. The non-transitory computer-readable storage medium of claim 11, wherein the specific temperature is 0.01.

13. The non-transitory computer-readable storage medium of claim 8, wherein the controller is a stochastic gradient-descent based reinforcement learning controller.

14. The non-transitory computer-readable storage medium of claim 13, wherein the controller comprises an A2C algorithm.

15. The non-transitory computer-readable storage medium of claim 8, wherein the temporal prediction network comprises:
a Long Short-Term Memory (LSTM) layer; and
a Mixture Density Network.

16. The non-transitory computer-readable storage medium of claim 11, wherein the software instructions, when executed by the processor, further cause the processor to output an action distribution from the controller, and wherein sampled actions from the action distribution maximize an expected reward on the first task.

17. A method of training an autonomous or semi-autonomous system, the method comprising:
training a temporal prediction network to perform a 1-time-step prediction on a first set of samples from an environment of the system during performance of a first task;
training a controller to generate an action distribution based on the first set of samples and a hidden state of the temporal prediction network, wherein sampled actions of the action distribution maximize an expected reward on the first task;
preserving the temporal prediction network and the controller as a preserved copy of the temporal prediction network and a preserved copy of the controller, respectively;
generating simulated rollouts from the preserved copy of the temporal prediction network and the preserved copy of the controller; and
interleaving the simulated rollouts with a second set of samples from the environment during performance of a second task to preserve knowledge of the temporal prediction network for performing the first task.

18. The method of claim 17, wherein the training the controller utilizes policy distillation including a cross-entropy loss function with a specific temperature of 0.01.

19. The method of claim 17, further comprising embedding, with a convolutional auto-encoder, the first set of samples collected during performance of the first task into a latent space.

20. The method of claim 17, wherein the controller is a stochastic gradient-descent based reinforcement learning controller comprising an A2C algorithm.

21. The method of claim 17, wherein the temporal prediction network comprises:
a Long Short-Term Memory (LSTM) layer; and
a Mixture Density Network.
